(19) United States
(12) Patent Application Publication
(10) Pub. No.: US 2012/0282512 A1
(43) Pub. Date: Nov. 8, 2012

(54) MANGANESE OXIDE NANOWIRE, RECHARGEABLE BATTERY INCLUDING THE SAME AND METHOD OF PRODUCING MANGANESE OXIDE

(75) Inventor: Shin Jung CHOI, Chungcheongnam-do (KR)

(73) Assignee: SAMSUNG CORNING PRECISION MATERIALS CO., LTD.

(21) Appl. No.: 13/445,883

(22) Filed: Apr. 12, 2012

(30) Foreign Application Priority Data
May 2, 2011 (KR) 10-2011-0041508

(51) Int. Cl. C01G 45/02; H01M 10/02; C01D 15/02; D01F 9/08; B82Y 40/00; B82Y 30/00

(52) U.S. Cl. 429/122; 423/605; 423/599; 428/401; 977/762; 977/896; 977/811

(57) ABSTRACT

Provided are a manganese oxide nanowire, specifically, a manganese oxide nanowire having an aspect ratio of 20 or more, which can be widely used in various fields, including batteries, oxygen generators, and redox catalysts, a rechargeable battery including the manganese oxide nanowire, and a method of producing manganese oxide. Since the manganese oxide nanowire having a large aspect ratio has an increased specific surface area, it can be effectively used in various fields. In addition, various kinds of manganese oxide nanowires can be simply manufactured.

### CROSS-REFERENCE TO RELATED APPLICATION

This application claims priority to and the benefit of Korean Patent Application No. 10-2011-0041508, filed on May 2, 2011, the entire content of which is incorporated herein by reference.

### BACKGROUND OF THE INVENTION

1. Field of the Invention

The present invention relates to a manganese oxide nanowire, specifically a manganese oxide nanowire having an aspect ratio of 20 or more, a rechargeable battery including the manganese oxide nanowire, and a method of producing the manganese oxide nanowire. More particularly, the present invention relates to a manganese oxide nanowire having an aspect ratio of 20 or more, which can be effectively used in various fields, including batteries, oxygen generators, and redox catalysts, owing to its increased specific surface area, a rechargeable battery including the same and a method of producing manganese oxide, by which various kinds of manganese oxide nanowires can be easily produced in a simplified manner.

2. Description of the Related Art

As the market in fields of cellular phones, notebook computers, electromotive vehicles, and so on, is on the rise, energy storage technology is gradually gaining attention.

Accordingly, electrochemical devices have gained highest attention, and major part of the electrochemical devices includes rechargeable batteries and capacitors. In order to improve the capacity and commercial viability of the electrochemical devices, active research into new material and design is under way. Currently commercially developing batteries include Ni—MH, Ni—Cd, Pb—PbSO₄, lithium ion batteries, and so on.

According to expansion of the lithium ion battery market, serious problems are encountered, including the sharp increase in prices of cobalt that is the most desirable positive electrode material and environmental pollution caused by cobalt. Under the circumstances, research into alternative materials is intensively conducted. In addition, particle sizes of metal oxide used as an electrode of a battery are reduced to a nanometer scale, a surface area of the metal oxide is increased, the charging/discharging speed and capacity of the battery can be increased, efforts to synthesize nano-scale electrode materials have continued. Attempts that have been made up to now were simply directed toward reduction in the particle size to a nano scale, but there was any research into a nanowire having a very large aspect ratio.

### BRIEF SUMMARY OF THE INVENTION

The present invention provides a manganese oxide nanowire, which can be effectively used in various fields.

The present invention also provides a rechargeable battery using the manganese oxide nanowire, which has high charge/discharge efficiency and capacity.

The present invention further provides a method of producing a manganese oxide nanowire, by which various kinds of manganese oxide nanowire can be easily produced in a simplified manner.

In accordance with one embodiment of the present invention, there is provided a manganese oxide nanowire having an aspect ratio of 20 or more.

The manganese oxide nanowire may be a βMnO₂ nanowire, a γMnOOH nanowire, or a LiₓMn₂O₄ nanowire.

The manganese oxide nanowire may have a line width in a range of 15 nm to 50 nm.

In accordance with another embodiment of the present invention, there is provided a battery including a manganese oxide nanowire having an aspect ratio of 20 or more.

In accordance with still another embodiment of the present invention, there is provided a method of producing a manganese oxide nanowire, the method including preparing a mixed solution including a manganese salt and an oxidant; adjusting a pH level by adding an alkali hydroxide salt to the mixed solution; and reacting the pH level adjusted mixed solution at a temperature in a range of 50° C. to 200° C. for 1 hour to 10 days.

As described above, the manganese oxide nanowire according to the present invention, is shaped of a wire having a very large aspect ratio, so that it has a specific surface area much larger than a general manganese oxide of a small particle size, that is, a nano size, and it can be effectively used with a rechargeable battery, an oxygen generator, or a redox catalyst.

In addition, since the method of producing manganese oxide according to the present invention is simplified, the production cost can be reduced. Further, since various kinds of manganese oxide nanowire can be easily produced through a single process by connecting processes for the various kinds of manganese oxide, desired manganese oxide nanowires can be appropriately produced as necessary.

In particular, when the manganese oxide nanowire according to the present invention is used as a material of a rechargeable battery, it is expected to improve the charging/discharging rates and capacity of the battery. That is to say, the manganese oxide nanowire according to the present invention can be alternatively used instead of expensive cobalt. Therefore, according to the present invention, a problem with environmental pollution may also be solved while saving the production cost.

Additional aspects and/or advantages of the invention will be set forth in part in the description which follows and, in part, will be obvious from the description, or may be learned by practice of the invention.

### BRIEF DESCRIPTION OF THE DRAWINGS

The objects, features and advantages of the present invention will be more apparent from the following detailed description in conjunction with the accompanying drawings, in which:

FIG. 1 is a scanning electron micrograph (SEM) image of a product prepared in Example 1;

FIG. 2 is an SEM image of a product prepared in Example 2;

FIG. 3 is an SEM image of a product prepared in Example 3;

FIG. 4 is an SEM image of a product prepared in Example 4;

FIG. 5 is an SEM image of a product prepared in Example 5;

FIG. 6 is an SEM image of a product prepared in Example 6;

FIG. 7 is an SEM image of a product prepared in Example 7;

FIG. 8 is an SEM image of a product prepared in Example 8;

FIG. 9 is an SEM image of a product prepared in Example 9;

FIG. 10 is an SEM image of a product prepared in Example 10;

FIG. 11 is an SEM image of a product prepared in Example 11;

FIG. 12 is an SEM image of a product prepared in Example 12;

FIG. 13 is an SEM image of a product prepared in Example 13;

FIG. 14 is an SEM image of a product prepared in Example 14;

FIG. 15 is an SEM image of a product prepared in Example 15;

FIG. 16 is an SEM image of a product prepared in Example 16;

FIG. 17 is an SEM image of a product prepared in Comparative Example 2;

FIG. 18 is an SEM image of a product prepared in Comparative Example 1;

FIG. 19 is a graph illustrating X-ray diffraction (XRD) analysis results of the product prepared in Example 7;

FIG. 20 is a graph illustrating XRD analysis results of the product prepared in Example 14;

FIG. 21 is a graph illustrating XRD analysis results of the products prepared in Examples 15 and 16; and

FIG. 22 illustrates cyclic voltammetry analysis results, in which curves (a), (b) and (c) are obtained by experiments according to Example 17, Comparative Example 3, and Comparative Example 4, respectively, where the scanning speed is 1 mV/sec.

### DETAILED DESCRIPTION OF THE INVENTION

Hereinafter, embodiments of the present invention will be described in detail with reference to the accompanying drawings.

The present invention provides a manganese oxide nanowire having an aspect ratio of 20 or more.

When the aspect ratio of a manganese oxide nanowire is 20 or more, the manganese oxide nanowire demonstrates the effect of significance when it is used as a nanowire, rather than a nanorod or nanoparticle.

According to an embodiment of the present invention, the manganese oxide nanowire is a βMnO₂, γMnOOH, or LiₓMn₂O₄ nanowire.

The γMnOOH nanowire is preferably used as a redox catalyst of water or oxygen, the βMnO₂ nanowire is preferably used with a primary battery, and the LiₓMn₂O₄ nanowire is preferably used with a secondary battery.

According to an embodiment of the present invention, the manganese oxide nanowire preferably has a line width of 15 to 50 nm.

Next, a method of producing the manganese oxide nanowire will be described in detail.

The method of producing the manganese oxide nanowire includes preparing a mixed solution including a manganese salt and an oxidant, adjusting a pH level by adding an alkali hydroxide salt to the mixed solution, and reacting the pH level adjusted mixed solution at a temperature in a range of 50° C. to 200° C. for 1 hour to 10 days, preferably at a temperature in a range of 100° C. to 200° C. for 5 to 20 hours.

At least one metal salt selected from the group consisting of MnSO₄, Mn(NO₃)₂, MnCl₂, Mn(CH₃COO)₂, and hydrates thereof can be used as the manganese salt.

At least one compound selected from the group consisting of (NH₄)₂S₂O₈, Li₂S₂O₈, Na₂S₂O₈, and K₂S₂O₈ can be used as the oxidant.

Here, 100 to 500 parts by weight of the oxidant is preferably used based on 100 parts by weight of the manganese salt.

If an excess of the oxidant is added compared to the amount of the manganese salt, that is to say, if the amount of the oxidant exceeds 500 parts by weight, the shape of the produced oxide may differ, disabling a nanowire structure to be attained. If a relatively small amount of the oxidant is added compared to the amount of the manganese salt, that is to say, if the amount of the oxidant is less than 100 parts by weight, an amount of unreacted manganese salts may increase, thereby lowering the reaction efficiency.

NaOH or KOH may be used as the alkali hydroxide salt, and the pH level of the reactant solution is adjusted by adding a small amount of the alkali hydroxide salt.

According to an embodiment of the present invention, the pH level is adjusted to be in a range of 9 to 11, preferably in a range of 9.3 to 10.5. The type of the produced oxide may differ according to the pH level. A desired nanowire structure is obtained within the pH range stated above. If the pH level is less than 9.3 or greater than 10.5, a nanowire structure can be obtained, but the obtained oxide has a composite oxide.

After the preparation is completed, the produced manganese oxide may be isolated from the reactant solution by a conventional precipitation method.

A γ-MnOOH nanowire obtained by a hydrothermal method is annealed in the air at a temperature in a range of 200° C. to 500° C. for 1 hour to 10 days, preferably at 250° C. to 400° C. for 1 to 24 hours, producing a β-MnO₂ nanowire.

The thus produced β-MnO₂ is mixed with a lithium salt in an organic solvent such as ethanol, methanol, ester, ether, etc., followed by annealing at a temperature in a range of 300° C. to 650° C., preferably at a temperature in a range of 500° C. to 600° C., for 1 hour to 10 days, to cause a solid phase reaction, producing a LiₓMn₂O₄ nanowire. Preferably, the annealing is performed for 3 to 20 hours to produce the LiₓMn₂O₄ nanowire.

Here, at least one metal salt selected from the group consisting of LiOH, LiNO₃, Li₂CO₃, Li(CH₃O), Li(CH₃CH₂O), Li(CH₃COO), Li₂O, and hydrates thereof can be used as the lithium salt. In LiₓMn₂O₄, an x value may vary according to the molar ratio of the lithium salt to β-MnO₂.

The manganese oxide nanowire produced by the above-described production method can increase the charging/discharging efficiency and capacity when it is used as a positive active material of a rechargeable battery.

The rechargeable battery may be fabricated by the method well known in the related art. For example, the manganese oxide nanowire may be used for a rechargeable battery including an electrode assembly including a first electrode and a second electrode each having an active material coated on an electrode current collector, and a separator interposed between the first and second electrodes, a case accommodating the electrode assembly, and an electrolyte injected into the case.

According to an embodiment of the present invention, the manganese oxide nanowire is used to fabricate a positive electrode in such a manner that a slurry including a conductive material, a binder and a solvent is coated on an aluminum (Al) substrate a positive electrode, which is a similar manner to the conventional positive electrode fabrication method.

The following examples illustrate the present invention in detail. These examples, however, should not in any sense be interpreted as limiting the scope of the present invention.

### Production of γ-MnOOH Nanowires

### Example 1

0.169 g of MnSO₄·H₂O and 0.228 g of (NH₄)₂S₂O₈ were dissolved in 100 ml distilled water, and KOH was added dropwise to adjust a pH level to 7. The reaction was allowed to take place in an oven at a temperature in a range of 130° C. for 10 hours by a hydrothermal method, followed by precipitation, thereby acquiring a solid. The acquired product was washed with distilled water several times and dried, yielding a solid material.

### Example 2

The same procedure as Example 1 was carried out, except that pH was adjusted to 9 by adding KOH.

### Example 3

The same procedure as Example 1 was carried out, except that pH was adjusted to 9.2 by adding KOH.

### Example 4

The same procedure as Example 1 was carried out, except that pH was adjusted to 9.4 by adding KOH.

### Example 5

The same procedure as Example 1 was carried out, except that pH was adjusted to 9.6 by adding KOH.

### Example 6

The same procedure as Example 1 was carried out, except that pH was adjusted to 9.8 by adding KOH.

### Example 7

The same procedure as Example 1 was carried out, except that pH was adjusted to 10.0 by adding KOH.

### Example 8

The same procedure as Example 1 was carried out, except that pH was adjusted to 10.2 by adding KOH.

### Example 9

The same procedure as Example 1 was carried out, except that pH was adjusted to 10.4 by adding KOH.

### Example 10

The same procedure as Example 1 was carried out, except that pH was adjusted to 10.6 by adding KOH.

### Example 11

The same procedure as Example 1 was carried out, except that pH was adjusted to 10.8 by adding KOH.

### Example 12

The same procedure as Example 1 was carried out, except that pH was adjusted to 11 by adding KOH.

### Example 13

The same procedure as Example 1 was carried out, except that pH was adjusted to 12 by adding KOH.

### Comparative Example 1

0.169 g of MnSO₄·H₂O· and 0.228 g of (NH₄)₂S₂O₈ were dissolved in 100 ml distilled water, and KOH was added dropwise to adjust pH to 10. The reaction was allowed to stand at room temperature for 10 hours, followed by precipitation, thereby acquiring a solid. The acquired product was washed with distilled water several times and dried, yielding a solid material.

### Production of β-MnO₂ Nanowire

### Example 14

The solid material acquired in Example 7 was annealed in the air at 300° C. for 3 hours, yielding a black solid material.

### Production of LiₓMn₂O₄ Nanowires

### Example 15

0.002 mol of the solid material acquired in Example 14 and 0.001 mol of LiOH·H₂O were mixed with a trace of ethanol to prepare a slurry. The slurry was annealed in the air at 500° C. for 10 hours, yielding LiMn₂O₄ as a black solid material.

### Example 16

The same procedure as Example 15 was carried out, except that high temperature annealing was performed at 600° C.

### Comparative Example 2

The same procedure as Example 15 was carried out, except that high temperature annealing was performed at 700° C.

### Fabrication of Rechargeable Battery

### Example 17

A battery is fabricated using 1 mg of the solid material acquired in Example 14 as a positive electrode material, 100 mg of zinc powder as a negative electrode material, 3M KOH aqueous solution as an electrolyte solution, and paper as a separator, and performance of the fabricated battery was tested by cyclic voltammetry analysis.

### Comparative Example 3

The same experiment as Example 18 was carried out, except that 1 mg of MnO₂ having an average particle size of 10 mm was used as a positive electrode material.

### Comparative Example 4

The same experiment as Example 17 was carried out, except that 1 mg of MnO₂ having an average particle size of 100 mm was used as a positive electrode material.

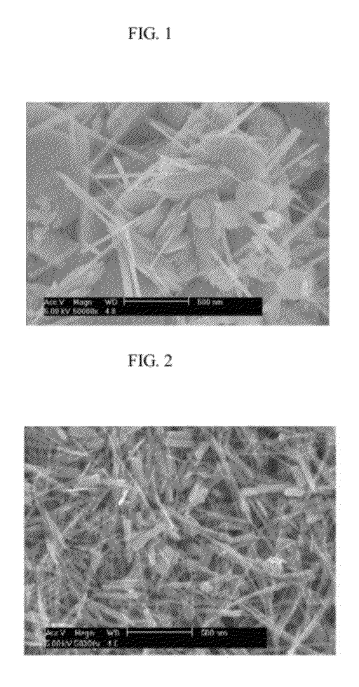

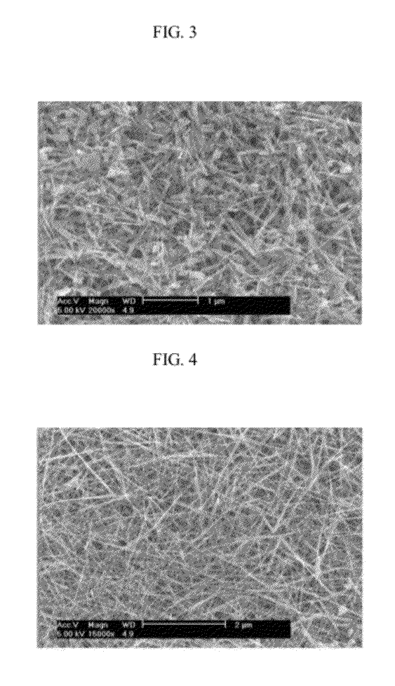

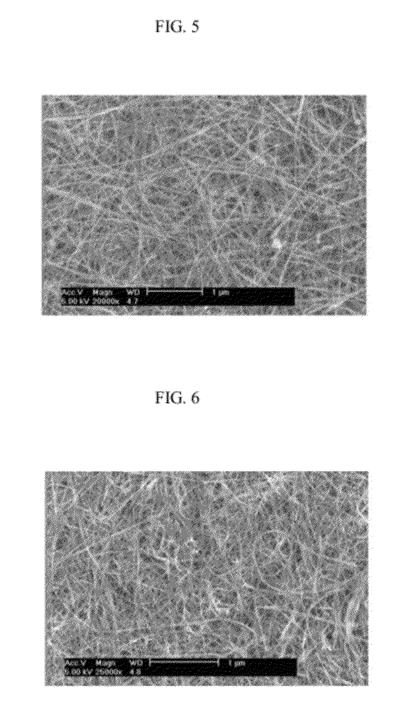

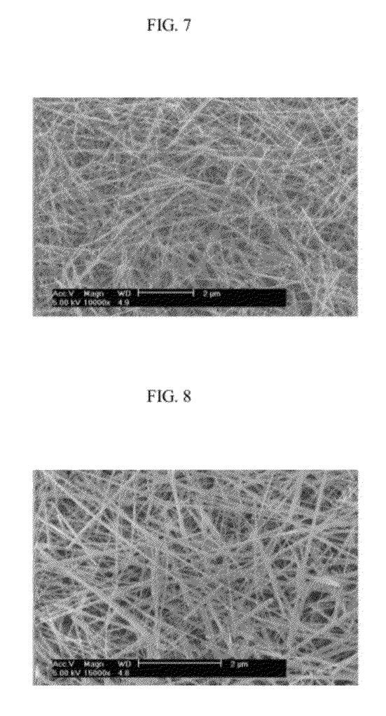

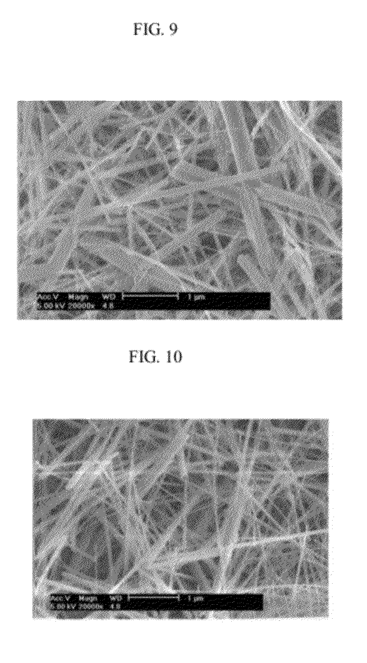

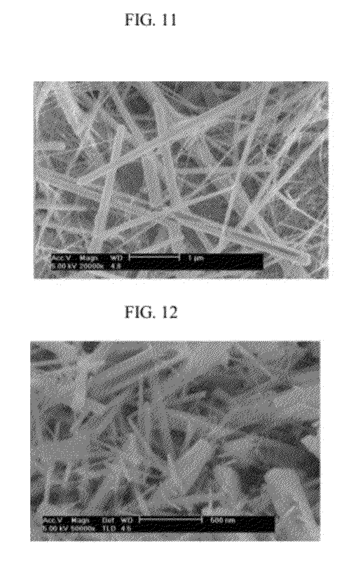

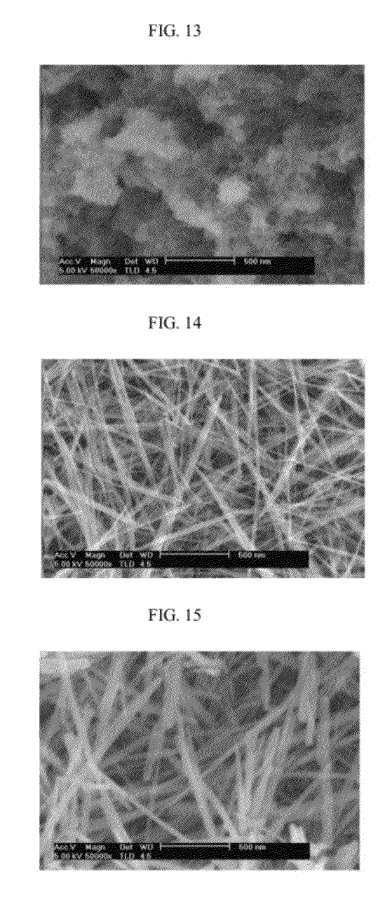

SEM images of the products acquired in Examples 1 to 13 are shown in FIGS. 1 to 13. As shown in FIGS. 1 to 13, the nanowires can be obtained by adjusting pH levels using a hydrothermal method. It is also understood that desired nanowires can be obtained in a pH range of 9.4 to 10.4. Here, it was confirmed that the nanowires had line widths of 50 nm or less and lengths of greater than several millimeters.

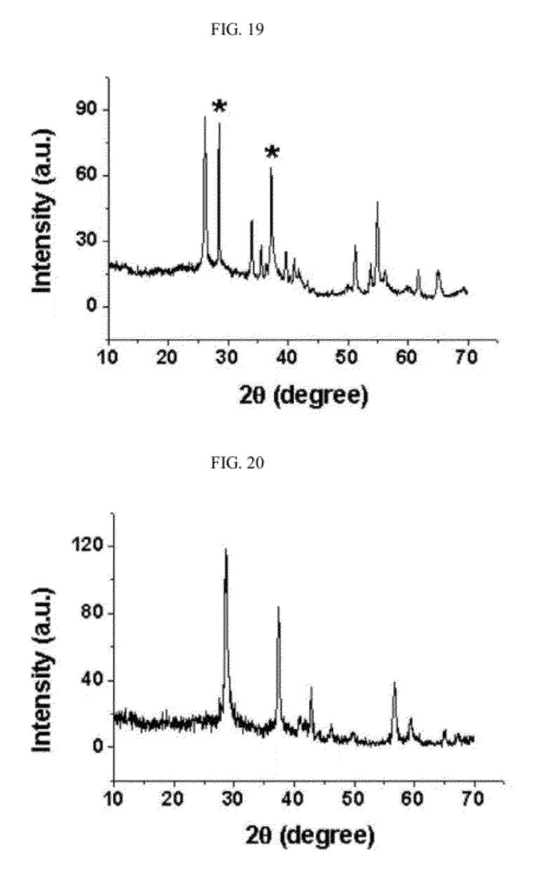

If the reaction was allowed to stand at room temperature without using a hydrothermal method, an amorphous oxide is yielded, as shown in FIG. 18. As confirmed from the XRD analysis result, the nanowires produced from the product using the hydrothermal method under a pH 10 condition are mostly γ-MnOOH nanowires, and some β-MnO₂ nanowires, as marked with asterisks, also exist (see FIG. 19).

Even after the nanowire produced under a pH 10 condition is annealed at 300° C., nanowire shapes are maintained, as shown in FIG. 14, and pure β-MnO₂ is obtained, as confirmed from the XRD analysis result shown in FIG. 20.

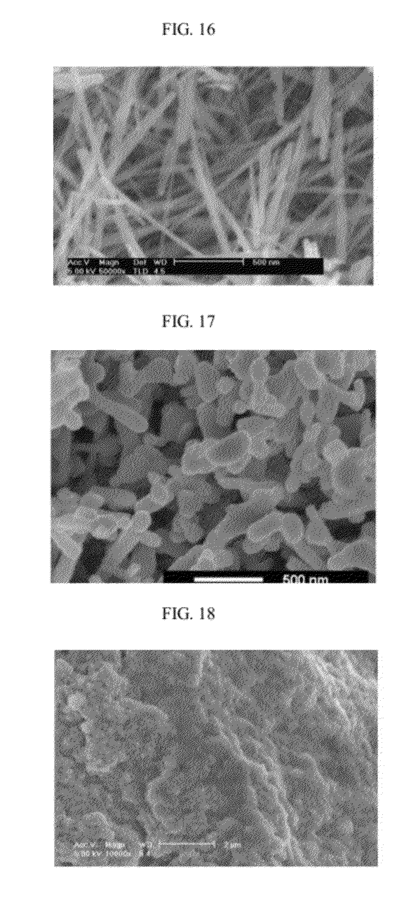

2 equivalents of β-MnO₂ and 1 equivalents of LiOH H₂O are mixed and annealed at a high temperature of 500° C. and 600° C. As a result, as shown in FIGS. 15 and 16, nanowire shapes are maintained. However, if the temperature is raised to 700° C., manganese oxide is melted and nanowire shapes are not maintained, as shown in FIG. 17.

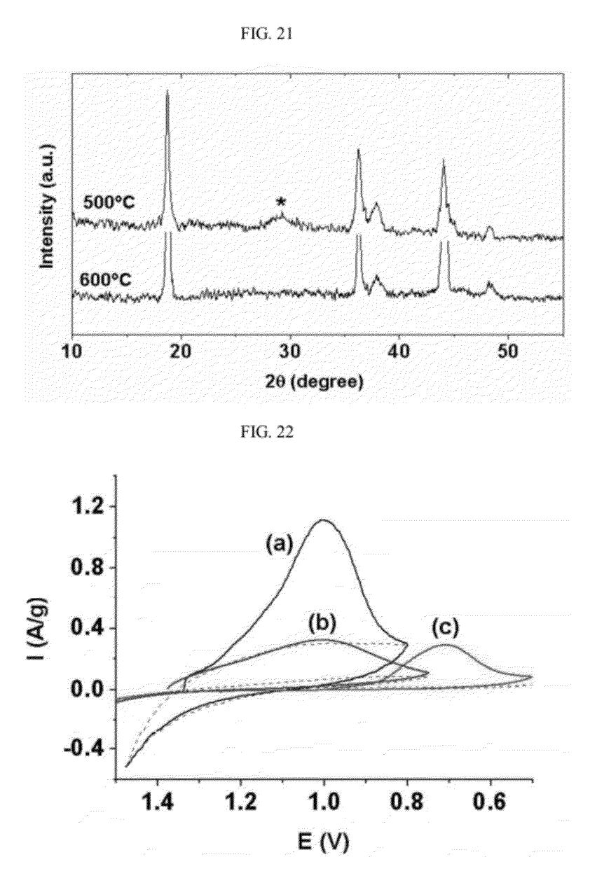

Referring to FIG. 21, 500° C., some of β-MnO₂, as marked with an asterisk, exists in the product obtained after high-temperature annealing for 10 hours. However, after high-temperature annealing at 600° C., pure LiMn₂O₄ is obtained.

When a Zn-MnO₂ battery was fabricated with the manganese oxide nanowire produced in Example 14 (Example 17) and a voltage was applied to the battery at a speed of 1 mV/sec, an electrode material demonstrated a discharge capacity of 91 mAh/g, as indicated by a curve (a) of FIG. 22). By contrast, electrode materials having average particle sizes of 10 mm and 100 mm demonstrated discharge capacities of 40 mAh/g and 20 mAh/g, as indicated by curves (b) and (c), respectively. Therefore, since the manganese oxide is produced in nanowire shapes, a surface area of the manganese oxide is increased, thereby increasing the charging/discharging speed and capacity.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined by the appended claims.

1: A manganese oxide nanowire having an aspect ratio of 20 or more.

2: The manganese oxide nanowire of claim 1, wherein the manganese oxide nanowire is a βMnO₂ nanowire, a γMnOOH nanowire, or a LiₓMn₂O₄ nanowire.

3: The manganese oxide nanowire of claim 1, wherein the manganese oxide nanowire has a line width in a range of 15 nm to 50 nm.

4: A battery including the manganese oxide nanowire of any one of claims 1 to 3.

5: A method of producing a manganese oxide nanowire, the method comprising:
preparing a mixed solution including a manganese salt and an oxidant;
adjusting a pH level by adding an alkali hydroxide salt to the mixed solution; and
reacting the pH adjusted mixed solution at a temperature in a range of 50° C. to 200° C. for 1 hour to 10 days.

6: The method of claim 5, wherein the manganese oxide nanowire is a γ-MnOOH nanowire.

7: The method of claim 5, wherein the manganese oxide nanowire is a β-MnO₂ nanowire, and the method further comprises annealing the manganese oxide nanowire in air at a temperature in a range of 200° C. to 500° C. for 1 hour to 10 days.

8: The method of claim 5, wherein the manganese oxide nanowire is a LiₓMn₂O₄ nanowire, and the method further comprises preparing a βMnO₂ nanowire by annealing the manganese oxide nanowire in the air at a temperature in a range of 200° C. to 500° C. for 1 hour to 10 days, and mixing the βMnO₂ nanowire with a lithium salt and annealing the mixture at a temperature in a range of 300° C. to 650° C. for 1 hour to 10 days.

9: The method of any one of claims 5 to 8, wherein the manganese oxide nanowire has an aspect ratio of 20 or more.

10: The method of any one of claims 5 to 8, wherein the pH level is in a range of 9.3 to 10.5.

11: The method of any one of claims 5 to 8, wherein the manganese salt is MnSO₄, Mn[NO₃]₂, MnCl₂, or Mn[CH₃COO]₂.

12: The method of any one of claims 5 to 8, wherein the oxidant is [NH₄]₂S₂O₈, Li₂S₂O₈, Na₂S₂O₈, or K₂S₂O₈.

13: The method of any one of claims 5 to 8, wherein 500 parts by weight of the oxidant is mixed based on 100 parts by weight of the manganese salt.

14: The method of any one of claims 5 to 8, wherein the lithium salt is at least one metal salt selected from the group consisting of LiOH, LiNO₃, Li₂CO₃, Li(CH₃O), Li(CH₃CH₂O), Li(CH₃COO), Li₂O, and hydrates thereof.
